(19) United States
(12) Patent Application Publication
(10) Pub. No.: US 2007/0112918 A1
(43) Pub. Date: May 17, 2007

(54) Systems and methods for screening chat requests

(76) Inventor: Viktors Berstis, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/274,849

(22) Filed: Nov. 15, 2005

(51) Int. Cl. G06F 15/16

(52) U.S. Cl. 709/206

(57) ABSTRACT

Systems, methods and media for screening member messages in an instant messaging environment are disclosed. In one embodiment, chat messages are stored as communications requests in a queue. A user-specified chat limit determines the maximum number of chats that may be taking place concurrently. When the chat limit is reached, additional requests received are placed in the queue, waiting to be processed. When a chat terminates, a next-out request is received from the queue and processed. Also, a user may specify a priority for each of a plurality of members in a communications network. A request from a user with special priority may be advanced to the head of the queue to be processed immediately.

### FIELD

The present invention is in the field of computer communications. More particularly, the invention relates to screening chat requests.

### BACKGROUND

Many different types of computing systems have attained widespread use around the world. These computing systems include personal computers, servers, mainframes and a wide variety of stand-alone and embedded computing devices. Sprawling client-server systems exist, with applications and information spread across many PC networks, mainframes and minicomputers. In a distributed system connected by networks, a user may access many application programs, databases, network systems, operating systems and mainframe applications. Computers provide individuals and businesses with a host of software applications including word processing, spreadsheet, and accounting. Further, networks enable high speed communication between people in diverse locations by way of e-mail, websites, instant messaging, and web-conferencing.

A common architecture for high performance, single-chip microprocessors is the reduced instruction set computer (RISC) architecture characterized by a small simplified set of frequently used instructions for rapid execution. Thus, in a RISC architecture, a complex instruction comprises a small set of simple instructions that are executed in steps very rapidly. These steps are performed in execution units adapted to execute specific simple instructions. In a superscalar architecture, these execution units typically comprise load/store units, integer Arithmetic/Logic Units, floating point Arithmetic/Logic Units, and Graphical Logic Units that operate in parallel. In a processor architecture, an operating system controls operation of the processor and components peripheral to the processor. Executable application programs are stored in a computer's hard drive. The computer's processor causes application programs to run in response to user inputs.

One such application is a client to manage instant messaging, chat sessions, and electronic meetings. The client is software that can execute in the processor of a computer. An excellent example is the IBM Lotus Sametime® client. A less comprehensive example is AOL Instant Messenger (AIM) service. Sametime is communications processing software that enables real-time communications between a plurality of users connected in a network. The network may be the Internet, or an intra-net, or a combination of both. Features of a communications processor such as Sametime Client include the ability to monitor the status of other users. A user may open a window which displays a list of people and their status. Status may include: active, inactive, away, do not disturb, etc. A user may specify his or her status as, for example, do-not-disturb. Also, different lists of people may be displayed. For example, a user may organize people into groups and display the status of each member of only one selected group at a time.

Sametime, and programs with similar functionality, enable instant messaging. A user clicks on an Instant Messaging icon and a window appears allowing the user to select a recipient to receive an instant message. The user types his message into a space in the window provided there for and then clicks a Send button to send the instant message. The message is immediately transmitted to the recipient. The message pops up in a window displayed on the recipient's computer monitor screen. The recipient can immediately type in a response and send it back to the user who initiated the communication. More advanced instant messaging software, such as Sametime, enables the messenger to insert audio and video into the message.

A user may also click on a Chat icon. A window appears allowing the user to select or input names of people to be invited to a chat. Then, when a user or a chat invitee sends a message, the message is sent to everyone else invited to the chat. A window appears that shows a chronological record of each person's message contributed to the chat. The window also shows the invitees to the chat and their status. The user may select an Ignore icon, to ignore a particular invitee's comments.

A problem arises when a busy person receives too many communications. For example, a busy user may be interrupted from his work by instant messages continually popping up on his computer screen. One option is to assert a global do-not-disturb status so that messages are still received in the background but do not interrupt work. This is unsatisfactory since some members of an instant messaging group have more important messages than others and the user may want to receive these important messages right away. Another option is to receive messages from only those members of the group or network whose messages are deemed high priority. This is unsatisfactory to the extent that urgent action messages from some members are not timely received.

What is needed therefore is a member message screening process that overcomes deficiencies of the prior art.

### SUMMARY

The problems identified above are in large part addressed by systems, methods and media for screening member messages. One embodiment is a communications processor to process instant messages and chat sessions among members of a network. The embodiment comprises memory to store a user-specified limit on a number of concurrent chat sessions involving one or more members and the user. The embodiment further comprises a queue to store incoming messages from members when the number of concurrent chat sessions equals or exceeds the user-specified limit. A logic mechanism processes an incoming message stored in the queue when a chat session ends.

Embodiments include a computer configurable to process communications between members of a network. The computer comprises memory to store instructions for processing messages received or to be transmitted by the computer, and to store messages received from one or more members. A processor executes instructions to perform communications processing functions, including determining if a number of concurrent chats equals or exceeds a user-specified chat limit. The functions further include processing a new chat message when the number of concurrent chats falls below the user-specified chat limit.

Another embodiment of the invention provides a machine-accessible medium containing instructions effective, when executing in a data processing system, to cause the system to perform a series of operations for processing chat messages received from one or more members of a network. The series of operations generally include storing received chat messages in a queue. The operation further includes determining if a number of concurrent chats equals or exceeds a user-specified chat limit, and processing a new chat message from the queue when the number of concurrent chats falls below the user-specified chat limit.

### BRIEF DESCRIPTION OF THE DRAWINGS

Advantages of the invention will become apparent upon reading the following detailed description and upon reference to the accompanying drawings in which, like references may indicate similar elements:

FIG. 1 depicts an embodiment of a digital system within a network; within the digital system is a processor.

FIG. 2 depicts an embodiment of a processor within a computer that may be configured to process communications requests.

FIG. 2A depicts a block diagram of an embodiment for processing communications requests.

FIG. 3 depicts a flowchart of an embodiment for receiving, storing and processing chat messages.

FIG. 4 depicts a flowchart of an embodiment for determining chat wait times and priority of messages.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Systems, methods and media for screening member messages in an instant messaging environment are disclosed. In one embodiment, chat messages are stored as communications requests in a queue. A user-specified chat limit determines the maximum number of chats that may be taking place concurrently. When the chat limit is reached, additional requests received are placed in the queue, waiting to be processed. When a chat terminates, a next-out request is received from the queue and processed. Also, a user may specify a priority for each of a plurality of members in a communications network. A request from a user with special priority may be advanced to the head of the queue to be processed immediately.

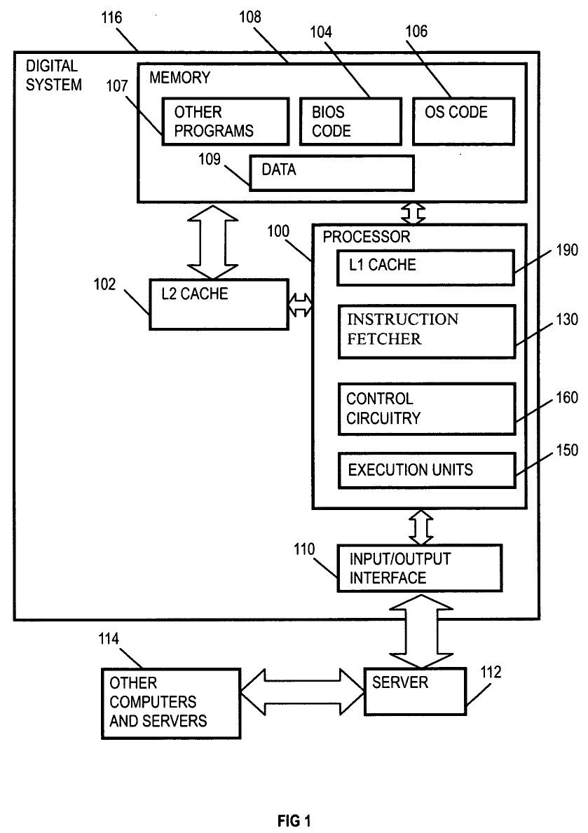

FIG. 1 shows a digital system 116 such as a computer or server implemented according to one embodiment of the present invention. Digital system 116 comprises a processor 100 that can operate according to BIOS (Basis Input/Output System) Code 104 and Operating System (OS) Code 106. The BIOS and OS code is stored in memory 108. The BIOS code is typically stored on Read-Only Memory (ROM) and the OS code is typically stored on the hard drive of computer system 116. Digital system 116 comprises a level 2 (L2) cache 102 located physically close to processor 100. Memory 108 also stores other programs for execution by processor 100 and stores data 109. In an embodiment, memory 108 stores communications processing computer code to process instant message communications, as will be described herein.

Processor 100 comprises an on-chip level one (L1) cache 190, an instruction fetcher 130, control circuitry 160, and execution units 150. Level 1 cache 190 receives and stores instructions that are near to time of execution. Instruction fetcher 130 fetches instructions from memory. Execution units 150 perform the operations called for by the instructions. Execution units 150 may comprise load/store units, integer Arithmetic/Logic Units, floating point Arithmetic/Logic Units, and Graphical Logic Units. Each execution unit comprises stages to perform steps in the execution of the instructions fetched by instruction fetcher 130. Control circuitry 160 controls instruction fetcher 130 and execution units 150. Control circuitry 160 also receives information relevant to control decisions from execution units 150. For example, control circuitry 160 is notified in the event of a data cache miss in the execution pipeline to process a stall.

Digital system 116 also typically includes other components and subsystems not shown, such as: a Trusted Platform Module, memory controllers, random access memory (RAM), peripheral drivers, a system monitor, a keyboard, a color video monitor, one or more flexible diskette drives, one or more removable non-volatile media drives such as a fixed disk hard drive, CD and DVD drives, a pointing device such as a mouse, and a network interface adapter, etc. Digital systems 116 may include personal computers, workstations, servers, mainframe computers, notebook or laptop computers, desktop computers, or the like. Processor 100 may also communicate with a server 112 by way of Input/Output Device 110. Server 112 connects system 116 with other computers and servers 114. Thus, digital system 116 may be in a network of computers such as the Internet and/or a local intranet. Further, server 112 may control access to other memory comprising tape drive storage, hard disk arrays, RAM, ROM, etc.

Thus, in one mode of operation of digital system 116, the L2 cache receives from memory 108 data and instructions expected to be processed in the processor pipeline of processor 100. L2 cache 102 is fast memory located physically close to processor 100 to achieve greater speed. The L2 cache receives from memory 108 the instructions for a plurality of instruction threads. Such instructions may include load and store instructions, branch instructions, arithmetic logic instructions, floating point instructions, etc. The L1 cache 190 is located in the processor and contains data and instructions preferably received from L2 cache 102. Ideally, as the time approaches for a program instruction to be executed, the instruction is passed with its data, if any, first to the L2 cache, and then as execution time is near imminent, to the L1 cache.

Execution units 150 execute the instructions received from the L1 cache 190. Execution units 150 may comprise load/store units, integer Arithmetic/Logic Units, floating point Arithmetic/Logic Units, and Graphical Logic Units. Each of the units may be adapted to execute a specific set of instructions. Instructions can be submitted to different execution units for execution in parallel. In one embodiment, two execution units are employed simultaneously to execute certain instructions. Data processed by execution units 150 are storable in and accessible from integer register files and floating point register files (not shown.) Data stored in these register files can also come from or be transferred to on-board L1 cache 190 or an external cache or memory. The processor can load data from memory, such as L1 cache, to a register of the processor by executing a load instruction. The processor can store data into memory from a register by executing a store instruction.

The processor of FIG. 1 within a computer such as system 116 can execute communications processing software to communicate with a plurality of members of a network, each member having a computer with communications processing software and being connected in a network through one or more servers. A server facilitates and coordinates communications between the computers in the network. Each computer has its own memory for storing its operating system, BIOS, and the code for executing application programs, as well as files and data. The memory of a computer comprises Read-Only-Memory (ROM), cache memory implemented in DRAM and SRAM, a hard disk drive, CD drives and DVD drives. The server also has its own memory and may control access to other memory such as tape drives and hard disk arrays. Each computer may store and execute its own application programs. Some application programs, such as databases, may reside in the server. Thus, each computer may access the same database stored in the server. In addition, each computer may access other memory by way of the server.

Thus, a user may be in communication with a large number of other members of a network such as the Internet, or an intra-net, or a combination of both. Each user communicates by a computer such as shown and described above. Each user computer comprises application software for communications processing. More particularly, a plurality of persons are “members” of a communications network or a group in the network, with each member having communications processing software on his or her computer. The communications processing software is executed in the(a) processor of the computer to empower the user to monitor the status of other members, initiate and respond to instant messages, and review and respond to chat input in one or more chat sessions. Thus, communications processing software dynamically configures the computer processor to execute communications processing functions as described herein.

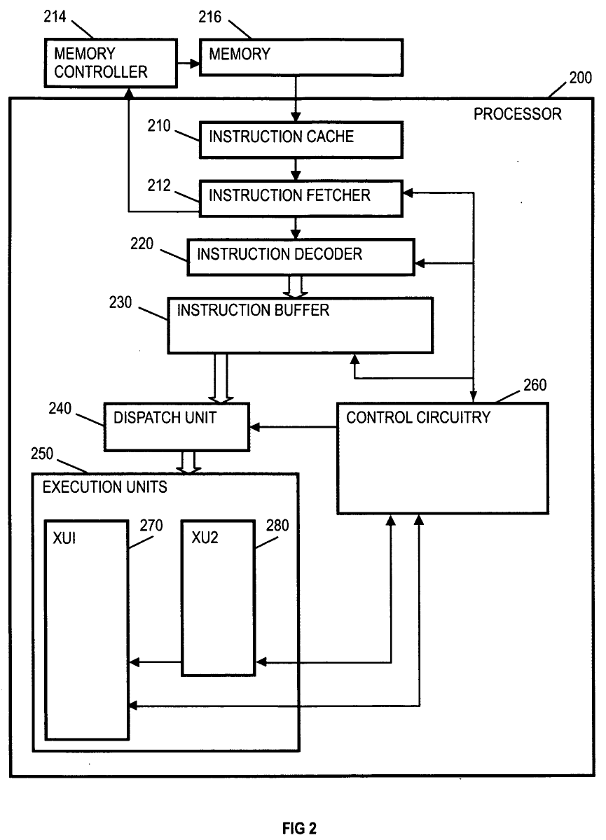

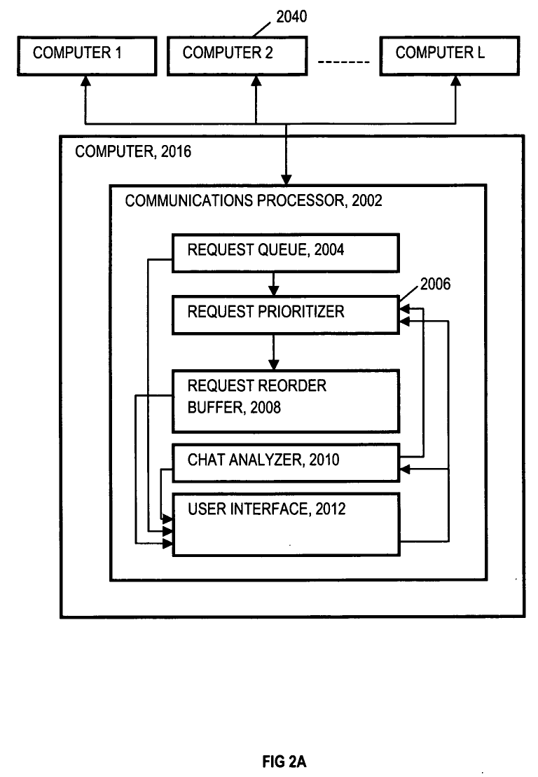

FIG. 2A shows a functional block diagram of a processor configured as a communications processor 2002, within a computer 2016 in a network of computers 2040. The network may, for example, be an intra-corporate network that is linked to the Internet. The communications processor 2002 is implemented by a processor, such as will be described with reference to FIG. 2, dynamically configured to execute communications processing software instructions.

The communications processor 2002 comprises memory for a request queue 2004 for receiving communication requests. A communication request is an instant message or chat message with attributes that include the screen name of the requestor and the message of the requestor. Other attributes of the request may include a priority of the request designated by the sender. Request queue 2004 receives these requests in the chronological order in which they arrive from the network. The memory for storing requests is configured as a First-In-First-Out (FIFO) buffer which stores up to a specifiable number of requests, M The number of requests, M, that can be stored in request queue 204 may be very large.

New message requests are input into the FIFO queue as received. Therefore, in one embodiment a request queue is provided to store a chronological sequence of communications requests. Request queue 2004 is viewable by the user through user interface 2012. User interface 2012 comprises an ability to display in a window on a computer monitor those who have sent messages, and their respective messages, in the order received. In an embodiment, the user may specify a limit N of chats that he may participate in at one time. All additional messages are placed in request queue 2004 which may also be called a wait queue. The respective members with requests in the queue are in a waiting status. When one of the N concurrent chats terminates, a next-out request in the queue may be processed. In particular, the next-out request is displayed for the user to respond.

Communications processor 2002 also comprises a request prioritizer 2006. Request prioritizer 2006 prioritizes requests according to criteria specified by a user. Thus, request prioritizer 2006 receives input from user interface 2012. For example, a user may input by way of keyboard and mouse (point, click and type) which members in a group of the network have special priority or which group has priority over other groups. For example, if a member would be in a waiting status because a limit of N chats is already reached, she may nevertheless be accorded special priority to instantly communicate with the user that accorded her priority status. Or alternatively, members given priority status will be placed at the head of a queue formed by a reorder buffer 2008.

Thus, communications processor 2002 may comprise a reorder buffer 2008, to store reordered requests received from request queue 2004. Each time one of N chats terminates, the system releases a new request for chat or instant message from the reorder buffer 2008, thus maintaining N concurrent chats. Therefore, a reorder buffer stores incoming messages in an order different from an order based on time of arrival of the messages according to one or more user-specified priorities. User interface 2012 comprises an ability to display in a window on a computer monitor those who have sent messages, and their respective messages, in the order of messages stored in reorder buffer 2008. Also displayed is a user-specified priority for each member with a request in the queue.

Communications processor 2002 further comprises a chat analyzer 2010. Chat analyzer 2010 acquires and compiles chat statistics. Chat statistics include the average time of a chat with each of a plurality of members and thus, an expected wait time that can be communicated to the member. Thus, chat analyzer 2010 times the durations of chats. Suppose for example that user Bob chats with member Joe for five minutes on average. As Bob chats with Joe, the time of their chat is subtracted from the average chat time between Bob and Joe to produce an expected remaining wait time that may be communicated to members in a waiting status. Or, if Bob chats concurrently with Joe and Fran, then the average of the average chat times with Joe and Fran may be communicated as an expected wait time. Alternatively, communications processor 2002 may implement other algorithms for determining an expected wait time.

These statistics, as well as others compiled by chat analyzer 2010, may be viewed by way of user interface 2012. Chat analyzer 2010 may also provide input to prioritizer 2006. Thus, chat analyzer 2010 may direct prioritizer 2006 to reorder chat requests according to some criteria. For example, chat analyzer 2010 may direct prioritizer 2006 to reorder chat requests from request queue 2004 and place them in the order of expected chat time with the requester. Therefore, those messages of members with the lowest expected chat time may be processed first.

FIG. 2 shows an embodiment of a processor 200 that can be implemented in a digital system such as digital system 116 to execute communications processing software as described herein. The processor 200 of FIG. 2 is configured to execute instructions of communications processor software to provide the functionality depicted in FIG. 2A. A level 1 instruction cache 210 receives instructions from memory 216 external to the processor, such as level 2 cache. Thus, communications processing software may be stored in memory as an application program. Groups of sequential instructions of the communications software can be transferred to the L2 cache, and subgroups of these instructions can be transferred to the L1 cache.

An instruction fetcher 212 maintains a program counter and fetches communications processing instructions from L1 instruction cache 210. The program counter of instruction fetcher 212 comprises an address of a next instruction to be executed. Instruction fetcher 212 also performs pre-fetch operations. Thus, instruction fetcher 212 communicates with a memory controller 214 to initiate a transfer of communications processing instructions from a memory 216 to instruction cache 210. The place in the cache to where an instruction is transferred from system memory 216 is determined by an index obtained from the system memory address.

Sequences of instructions are transferred from system memory 216 to instruction cache 210 to implement communications processing functions. For example, a sequence of instructions may instruct the processor to determine an expected wait time to be posted to a member waiting to chat with the user. Another group of instructions may instruct the processor to determine if a member whose request has just been received has a special priority. Yet another group of instructions may instruct the processor to process a next-out request from the FIFO request buffer.

Instruction fetcher retrieves communications processing instructions passed to instruction cache 210 and passes them to an instruction decoder 220. Instruction decoder 220 receives and decodes the instructions fetched by instruction fetcher 212. Instruction buffer 230 receives the decoded instructions from instruction decoder 220. Instruction buffer 230 comprises memory locations for a plurality of instructions. Instruction buffer 230 may reorder the order of execution of instructions received from instruction decoder 220. Instruction buffer 230 therefore comprises an instruction queue to provide an order in which instructions are sent to a dispatch unit 240.

Dispatch unit 240 dispatches communications processing instructions received from instruction buffer 230 to execution units 250. In a superscalar architecture, execution units 250 may comprise load/store units, integer Arithmetic/Logic Units, floating point Arithmetic/Logic Units, and Graphical Logic Units, all operating in parallel. Dispatch unit 240 therefore dispatches instructions to some or all of the executions units to execute the instructions simultaneously. Execution units 250 comprise stages to perform steps in the execution of instructions received from dispatch unit 240. Data processed by execution units 250 are storable in and accessible from integer register files and floating point register files not shown. Thus, instructions are executed sequentially and in parallel.

FIG. 2 shows a first execution unit (XU1) 270 and a second execution unit (XU2) 280 of a processor with a plurality of execution units. Each stage of each of execution units 250 is capable of performing a step in the execution of a different communications processing instruction. In each cycle of operation of processor 200, execution of an instruction progresses to the next stage through the processor pipeline within execution units 250. Those skilled in the art will recognize that the stages of a processor “pipeline” may include other stages and circuitry not shown in FIG. 2.

Moreover, by multi-thread processing, multiple communications processes may run concurrently. For example, by executing instructions of different threads, the processor can time chats while also determining the priority of a member from whom a chat request has been just received. As another example, by executing instructions of different threads, the processor can determine if a chat limit N is exceeded by a new request while also computing an expected wait time for a chat with a particular member. Thus, a plurality of instructions may be executed in sequence and in parallel to perform communications processing functions.

FIG. 2 also shows control circuitry 260 to perform a variety of functions that control the operation of processor 200. For example, an operation controller within control circuitry 260 interprets the OPCode contained in an instruction and directs the appropriate execution unit to perform the indicated operation. Also, control circuitry 260 may comprise a branch redirect unit to redirect instruction fetcher 212 when a branch is determined to have been mispredicted. Control circuitry 260 may further comprise a flush controller to flush instructions younger than a mispredicted branch instruction.

Branches may arise from performing a plurality of communications processing functions. For example, determining if a member has special priority involves a branch instruction. If a member has special priority, then a sequence of instructions is followed to advance the member request to the head of the queue. If a member does not have special priority, then a sequence of instructions is executed to place the request in the last-in position of the queue. Determining if a chat limit has been exceeded also involves a branch instruction. If a chat limit is not exceeded, then a sequence of instructions is executed to receive and process the next-out request from the queue. Control logic for executing branch instructions is thus provided by control circuitry 260.

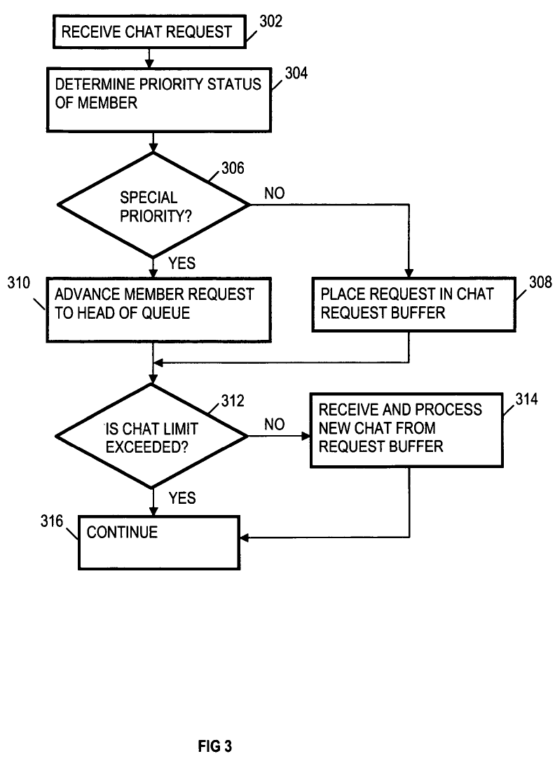

As mentioned, a communications processor 2002 performs a plurality of processes concurrently. FIG. 3 shows a flow chart 300 of an embodiment of a chat request process performed by communications processor 2002. In the course of operation, a user's computer receives an instant message or chat message from a member (element 302). The system determines the priority status of the requesting member (element 304). If the member has special priority (element 306), then the member's re quest is advanced to the head of the FIFO request queue (element 310). Or alternatively, the request is displayed right away without waiting. If the member does not have special priority (element 306), then the member's request is placed in the last-in position of the FIFO request queue (element 308).

At the time of receipt of a request, the user's specified chat limit N may or may not be exceeded (element 312). If the number of concurrent chats does not equal or exceed the self-imposed user limit, then the processor receives and processes the next-out request in the FIFO request buffer (element 3314). And the process continues. If, however, the number of concurrent chats does exceed limit N, then the process continues without yet processing a new request from the FIFO buffer (element 316). Thus, when N concurrent chat sessions occur, new requests are placed in a request queue. Each time a chat session ends, the next-out request in the queue is processed. In particular, the request message is displayed, enabling the user to respond.

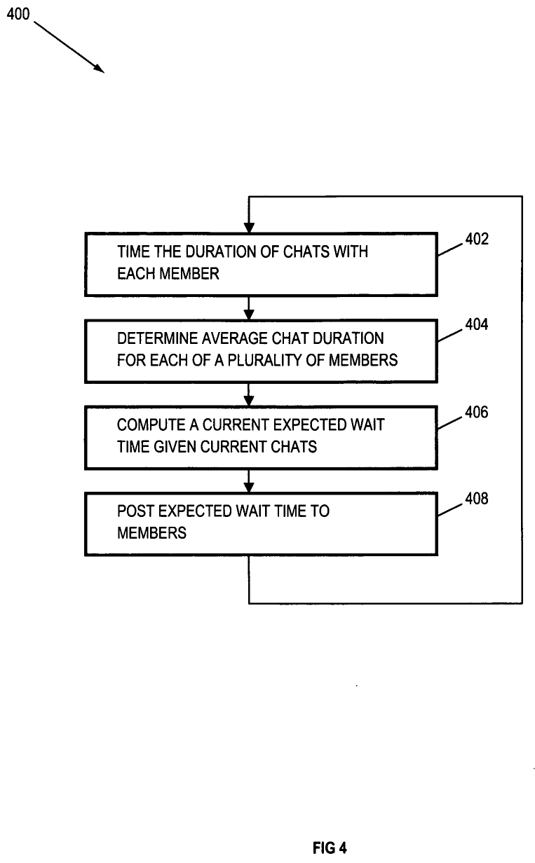

FIG. 4 shows a flow chart 400 of an embodiment for aggregating and processing statistics performed by communications processor 2002. The system continually times the duration of chats with each member (element 402). The system uses this information to determine an average chat duration per member (element 404). From this information the system determines a current expected wait time, given the current chat sessions (element 406). For example, suppose the current chats are with Ted and Sue. Then the average chat time with Ted and the average chat time with Sue are determined. Suppose that the average chat time for Ted and Sue are 15 and 7 minutes, respectively.

Suppose further that the current chats have been going on for 5 minutes with Ted and 3 minutes for Sue. Then the expected remaining time to chat with Ted is 10 minutes, and with Sue, 4 minutes. The system might then determine the expected wait time to be 4 minutes. The expected wait time is then posted to the members with requests waiting in the request queue (element 408). More particularly, the expected wait time of 4 minutes is posted to the member whose request is in the first-out position in the FIFO queue. Suppose further, then, that the average chat time with the member in the first-out position is 8 minutes. Then the expected chat time posted to the second-out position in the queue will be 12 (=4+8) minutes. And so forth. Thus, the wait times may be concatenated according to the order of requests in the queue.

Some embodiments of the invention are implemented as a program product for use with a computer system such as, for example, the system 116 shown in FIG. 1. The program product could be used on other computer systems or processors. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-accessible format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Thus, another embodiment of the invention provides a machine-accessible medium containing instructions effective, when executing in a data processing system, to cause the system to perform a series of operations for processing chat messages received from one or more members of a network. The series of operations generally include storing received chat messages in a queue. The operations further include determining if a number of concurrent chats equal or exceed a user-specified chat limit, and processing a new chat message from the queue when the number of concurrent chats falls below the user-specified chat limit. Operations may further comprise determining an expected chat duration, communicating expected chat durations to members in the network, and prioritizing received chat messages according to user-specified criteria.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A communications processor to process instant messages and chat sessions among members of a network, comprising:
memory to store a user-specified limit on a number of concurrent chat sessions involving one or more of the members and the user;
a queue to store incoming messages from additional members when the number of concurrent chat sessions equals or exceeds the user-specified limit; and
a logic mechanism to process one of the incoming messages stored in the queue when a chat session of the concurrent chat sessions ends.

2. The communications processor of claim 1, further comprising a chat analyzer to time durations of the chat sessions.

3. The communications processor of claim 2, wherein the chat analyzer comprises logic to determine an expected wait time to inform one or more of the additional members whose incoming messages are in the queue of the expected wait time.

4. The communications processor of claim 1, further comprising a reorder buffer to store incoming messages in an order different from an order based on time of arrival of the incoming messages according to one or more user-specified priorities.

5. The communications processor of claim 1, further comprising a prioritizer to reorder incoming messages according to priority assigned to one or more of the members of the network.

6. A computer configurable to process communications between members of a network; comprising:
memory to store instructions for processing messages received or to be transmitted by the computer, and to store messages received from one or more of the members; and
a processor to execute instructions to perform communications processing functions, comprising:
determining if a number of concurrent chats equals or exceeds a user-specified chat limit; and
processing a new chat message when the number of concurrent chats falls below the user-specified chat limit.

7. The computer of claim 6, further comprising an interface to display a queue of the members from whom chat messages have been received and are waiting to be processed.

8. The computer of claim 6, wherein the processor is adapted to perform communications processing functions comprising assigning a priority to a group of one or more of the members and processing messages from a member of the group ahead of previously received messages from non-members of the group.

9. The computer of claim 6, wherein the processor is adapted to perform communications processing functions comprising timing a duration of one or more of the chats.

10. The computer of claim 6, wherein the processor is adapted to perform communications processing functions comprising determining an expected chat time.

11. The computer of claim 10, wherein the processor is adapted to perform communications processing functions comprising sending a determined expected chat time to a member in a waiting status.

12. The computer of claim 6, wherein the messages are first stored in memory configured as a first-in-first-out buffer in an order received.

13. The computer of claim 12, wherein the messages are next stored in a prioritized order in memory.

14. A machine-accessible medium containing instructions for processing chat messages received from one or more members of a network, which, when executed by a machine, cause said machine to perform operations, comprising:
storing received chat messages in a queue;
determining if a number of concurrent chats equals or exceeds a user-specified chat limit; and
processing a new chat message from the queue when the number of concurrent chats falls below the user-specified chat limit.

15. The machine accessible medium of claim 14, wherein the operations further comprise determining at least one expected chat duration.

16. The machine accessible medium of claim 15, wherein the operations further comprise communicating the at least one expected chat duration to members in the network.

17. The machine accessible medium of claim 14, wherein the operations further comprise prioritizing received chat messages according to user-specified criteria.

18. The machine accessible medium of claim 17, wherein the operation further comprises grouping received chat messages according to their priority.

19. The machine accessible medium of claim 14, wherein the operations further comprise displaying a list of members whose messages are in the queue.

20. The machine accessible medium of claim 19, wherein the display shows the order in which messages are waiting in the queue.
